(19) United States
(12) Patent Application Publication
(10) Pub. No.: US 2010/0046240 A1
(43) Pub. Date: Feb. 25, 2010

(54) DECORATIVE SLEEVE FOR FLAMELESS CANDLE

(76) Inventor: Karen Marden, Shrewsbury, MA (US)

Correspondence Address: ELMORE PATENT LAW GROUP, PC, 515 Groton Road, Unit 1R, Westford, MA, 01886, US

(21) Appl. No.: 12/544,579

(22) Filed: Aug. 20, 2009

Related U.S. Application Data
(60) Provisional application No. 61/091,066, filed on Aug. 22, 2008.

(51) Int. Cl. F21V 35/00; B23P 17/04

(52) U.S. Cl. 362/392; 29/557

(57) ABSTRACT

A removable, decorative sleeve for wax-surfaced flameless candles comprising a cylindrical, open-ended form wherein the form is made of one or more preferably overlapping layers of a flexible, transparent or translucent material such as, but not limited to, plastic laminate. The sleeve is decorated in a manner such that the light emitting from the flameless candle passes through the form and serves to accentuate the decoration. Once applied, the sleeve remains in place substantially by friction between the form and the wax surface of the flameless candle.

### RELATED APPLICATION

This application claims the benefit of U.S. Provisional Application No. 61/091,066 filed Aug. 22, 2008. The entire teachings of the above application are incorporated herein by reference.

### TECHNICAL FIELD

This invention pertains to the decorative arts in general, and in particular, to a device which allows the removable, replaceable and customizable decoration of wax or similarly surfaced flameless candle.

### BACKGROUND OF THE INVENTION

In many instances where a real candle can be used, a flameless candle can be substituted, with little sacrifice of attractive ambiance, or authentic appearance. Often, the bodies of flameless candles are comprised of real candle wax, thus retaining the attractiveness, the authenticity, the pleasant glow qualities, and the differing dimensional features of a real candle.

Decorated wax or similarly based flameless candles are currently available. The drawback of these products lies in the fact that the decoration is either embedded in, or printed directly on, the body of the candle. The use of traditional candles as décor items throughout the year is common. They are often changed or replaced with different designs, colors or logos based on seasons (calendar or sports), holidays or events. This requires a multitude of candles that must be moved, stored and protected. If the candles are actually lit, the decoration will burn away as the candle is consumed.

The current invention seeks to address these issues by providing flameless candle sleeves which may be decorated in any number of ways based on the needs of the user, and which may be easily removed and replaced with another design at any time. This eliminates the need for multiple candles and the associated burdens previously mentioned.

### SUMMARY OF THE INVENTION

The present invention provides a removable, customizable decorative sleeve that slides on and off of differently sized wax or similarly surfaced flameless candles, thereby changing the appearance of the candle. The sleeves are thin, giving the candle a natural look and allowing the chosen design to appear as if it were part of the candle.

The sleeve is constructed of one or more layers of a decorated translucent or transparent material which allows the light emitting from the flameless candle to pass through the sleeve thereby highlighting, accenting and enhancing the decoration in the manner of a traditional wax candle.

The sleeve is sized such that it is supported by friction between its inside diameter and the outside diameter of the flameless candle. It may be decorated pre or post installation by various means, including but not limited to, pre-printing, handpainting, tattooing, screen printing and sticker application.

### BRIEF DESCRIPTION OF THE DRAWINGS

FIG. 1 illustrates a sleeve of the invention ready to be fitted around the candle.

FIG. 2 illustrates a sleeve before it has been fitted to a candle.

### DETAILED DESCRIPTION OF THE INVENTION

As discussed above, the invention relates to a removable, decorative sleeve for candles, preferably flameless candles. The sleeve may be customized in height, inside diameter, edge contour and décor by the end user or it may be provided with various heights, inside diameters, edge contours and decors by the manufacturer.

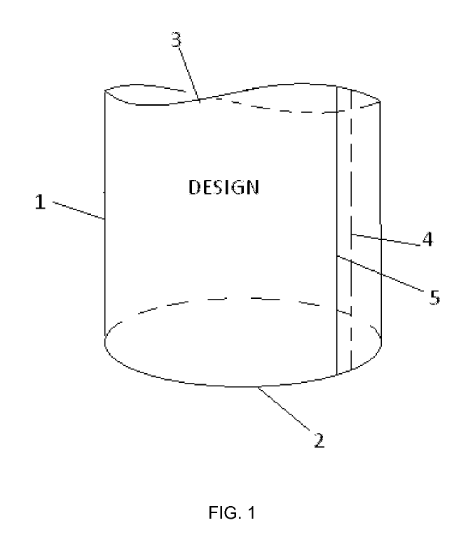

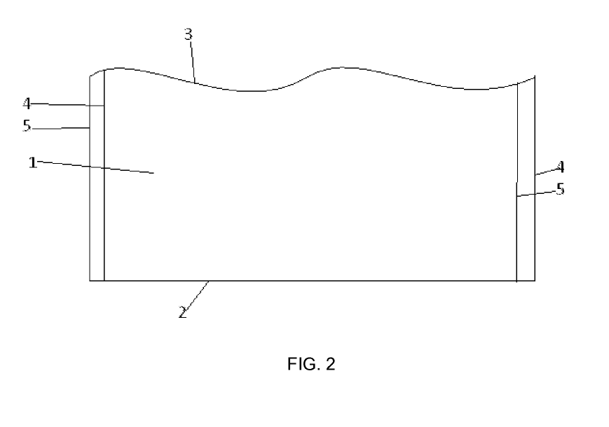

Referring to FIG. 1, a preferred embodiment of the invention features a removable, decorative sleeve 1 for candles, such as wax-surfaced flameless candles, comprising a cylindrical form, open at both ends 2 and 3, and which is made of one or more preferably overlapping layers, illustrated as the area bounded by lines 4 and 5, of a flexible, transparent or translucent material such as, but not limited to, Orafol PVC Film. In the preferred embodiment where two layers of material are used, the top layer features an adhesive side while the bottom layer is untreated (or vice versa). The decorations can be applied in a manner such that when the material layers are overlapped, the decorations (shown here by the word Design) are sandwiched between the layers and therefore protected from chafe. One edge, the area(s) bounded by one or both pairs of lines 4 and 5, of the adhesive side of the top material layer is left exposed. FIG. 2 illustrates the sleeve before its assembly. This edge will adhere to the material when the cylindrical shape of the appropriate diameter is formed. The sleeve is decorated in a manner such that the light emitting from the flameless candle passes through the sleeve and serves to accentuate the decoration. The inside diameter of the sleeve is at least equal to the diameter of the flameless candle to which it is applied so that it may be slid over and surround the candle. In a preferred embodiment, the height(s) of the sleeve is less than or equal to the height(s) of the flameless candle to which it is applied and is preferably contoured to match the topography of the candle, as illustrated by line 2 of FIG. 1. As shown in FIG. 1, the sleeve, once applied, remains in place substantially by friction between the sleeve and the surface of the flameless candle. For safety reasons, the transparent or translucent material would preferably be flame retardant.

An alternative embodiment would allow the use of flameless candles which have a surface other than traditional wax but which allow the sleeve to remain in place substantially by friction between the sleeve and the surface of the candle.

Based on end-user preference, the invention can be provided in different forms which will allow varying degrees of customization:
a) Pre-sized and pre-formed for a given flameless candle size;
b) As in (a) and decorated;
c) As in (a) and undecorated;
d) In sheets which are of common sizes, suitable for use in a home printer and which provide a means along one edge for adhering to itself for the purpose of forming the cylindrical shape once the sheet has been printed and cut to size;
e) As in (d) and decorated;
f) As in (d) and undecorated.

The invention includes kits for creating candle sleeves comprising the sheets, as described in (d) together with one or more decorating elements, including but not limited to stamps, stickers, decals, stencils, tattoos, paints and the like and methods for producing the candle sleeves.

For example, the invention includes a process for decorating a flameless candle comprising the steps of:
a. Placing a desired design onto a sheet of non-adhesive transparent or translucent material, for example using a printer, painting, or other means of decorating;
b. Sizing the sleeve under construction by overlapping the edges of the sheet so as to surround the circumference of the flameless candle such that the material will remain in place substantially due to friction between the sleeve and the flameless candle;
c. Marking the inside diameter of the sleeve along the contour of the top edge of the flameless candle and along the vertical overlapping edge of the material;
d. Application of a material sheet featuring one adhesive side to the non-adhesive sheet decorated in previous steps such that; the decorations are sandwiched between the two sheets and; the adhesive side extends beyond the non-adhesive sheet in such a manner that the sheet will adhere to itself when re-formed into the cylindrical shape;
e. Trimming the layered sleeve in accordance with the inside diameter marks of step (c);
f. Forming the cylindrical shape of the sleeve with the layered material such that; the overlapping edge of the non-adhesive layer aligns with the vertical mark made in step (c);
g. Pressing the exposed adhesive edge of the top layer such that it adheres to itself, thereby maintaining the cylindrical shape;
h. Placing the sleeve onto the candle such that the sleeve edge trimmed in step (e) aligns appropriately with the contour of the top of the flameless candle.

While this invention has been particularly shown and described with references to preferred embodiments thereof, it will be understood by those skilled in the art that various changes in form and details may be made therein without departing from the scope of the invention encompassed by the appended claims.

What is claimed is:

1. A removable, decorative sleeve for flameless candles comprising an approximately cylindrical form, open at both ends wherein; said sleeve is made of one or more preferably overlapping layers of a flexible, transparent or translucent material such as, but not limited to, laminate; said sleeve is decorated in a manner such that the light emitting from the flameless candle passes through said sleeve and serves to accentuate the decoration and; the inside diameter of said sleeve is at least equal to the outer diameter of the flameless candle to which it is applied and; the height of said sleeve is less than or equal to the height of the flameless candle to which it is applied and; once applied, remains in place substantially by friction between the sleeve and the surface of the flameless candle.

2. The sleeve of claim 1 wherein the transparent or translucent material is flame retardant.

3. The sleeve of claim 1 wherein the flameless candle comprises a wax surface that allows said sleeve to remain in place substantially by friction between the sleeve and the surface of the candle.

4. The sleeve of claim 1 wherein decoration of said sleeve may occur by hand application, printing or any other process suitable for rendering an image onto the material.

5. The sleeve of claim 1 wherein the material may be provided pre-sized and preformed for a given flameless candle size and contour or topography.

6. The sleeve of claim 6 wherein the material may be provided pre-decorated or undecorated.

7. The sleeve of claim 1 wherein the material may be provided in sheets which are of common sizes and which would allow their use in a home printer.

8. The sleeve of claim 7 wherein the sheets of material provide a means along one edge for adhering to itself for the purpose of forming the cylindrical shape.

9. The sleeve of claim 1 wherein sleeve comprises a top and bottom layer that overlap at the point of intersection; the top or bottom layer have one adhesive side while both sides of the other layer are untreated and; decorations of said sleeve are applied in a manner such that when the material layers are overlapped, the decorations are sandwiched between the layers thereby protecting them from chafe and; when the material layers are overlapped, a portion of the adhesive side of the top material layer is left exposed which will facilitate adherence to itself when the appropriate diameter cylindrical form is created.

10. A decorated flameless candle which comprises a flameless candle surrounded by the sleeve of claim 1.

11. A process for decorating a flameless candle comprising the steps of:
a. Placing a desired design onto a sheet of non-adhesive transparent or translucent material, for example using a printer, painting, or other means of decorating;
b. Sizing the sleeve under construction by overlapping the edges of the sheet so as to surround the circumference of the flameless candle such that the material will remain in place substantially due to friction between the sleeve and the flameless candle;
c. Marking the inside diameter of the sleeve along the contour of the top edge of the flameless candle and along the vertical overlapping edge of the material;
d. Application of a material sheet featuring one adhesive side to the non-adhesive sheet decorated in previous steps such that; the decorations are sandwiched between the two sheets and; the adhesive side extends beyond the non-adhesive sheet in such a manner that the sheet will adhere to itself when re-formed into the cylindrical shape;
e. Trimming the layered sleeve in accordance with the inside diameter marks of step (c);
f. Forming the cylindrical shape of the sleeve with the layered material such that; the overlapping edge of the non-adhesive layer aligns with the vertical mark made in step (c);
g. Pressing the exposed adhesive edge of the top layer such that it adheres to itself, thereby maintaining the cylindrical shape;
h. Placing the sleeve onto the candle such that the sleeve edge trimmed in step (e) aligns appropriately with the contour of the top of the flameless candle.
